(19) United States
(12) Patent Application Publication
(10) Pub. No.: US 2011/0003592 A1
(43) Pub. Date: Jan. 6, 2011

(54) Control Method of Wireless Communication Terminal and Wireless Communication Terminal

(75) Inventor: Hiroyuki Matsumoto, Kanagawa (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/865,075

(22) PCT Filed: Jan. 28, 2009
(86) PCT No.: PCT/JP2009/051323

§ 371 Date: Jul. 28, 2010

(30) Foreign Application Priority Data
Jan. 29, 2008 (JP) 2008-018275

(51) Int. Cl. H04W 48/18

(52) U.S. Cl. 455/434

(57) ABSTRACT

A wireless communication terminal 100 capable of using a femtocell and a public network is provided with a system control unit 150 for controlling, if a transmission request detection unit 150f detects a communication transmission request when a public network is in an idle state and a femtocell is not in the idle state, a system scan unit 150g to perform system scan of the femtocell before corresponding transmission processing is performed in the public network in the idle state and for controlling, if the femtocell is detected by system scan, the transmission processing to be performed not by the public network in the idle state but by the femtocell.

### CROSS REFERENCE TO RELATED APPLICATION

This application claims priority to and the benefit of Japanese Patent Application No. 2008-18275 (filed on Jan. 29, 2008), the entire content of which is incorporated herein by reference.

### TECHNICAL FIELD

The present invention relates to a control method of a wireless communication terminal capable of using a first wireless communication system supporting communication with a femtocell and a second wireless communication system supporting communication with a public network, and also relates to a wireless communication terminal capable of using the first wireless communication system supporting the communication with the femtocell and the second wireless communication system supporting the communication with the public network.

### BACKGROUND ART

A mobile communication system using CDMA (Code Division Multiple (Access) method generally employs a plurality of methods to transmit data including video data, which are transmitted and received by an application such as IP-VT (Video Telephone) or the like.

For example, the CDMA2000 standard defines three communication systems to transmit data: CDMA2000 1x that employs a circuit switching method; CDMA2000 1x EV-DO Rev.0 that employs a packet switching method and supports data rates (transmission speed) of uplink up to about 153.6 kbps and downlink up to about 2.4 Mbps; and CDMA2000 1x EV-DO Rev.A that is an accelerated Rev.0 system and supports data rates (transmission speed) of uplink up to about 1.8 Mbps and downlink up to about 3.1 Mbps (see Non Patent Document 1 and Non Patent Document 2).

Moreover, CDMA2000 1x EV-DO Rev.A has a feature that a function for controlling QoS (Quality of Service) is added.

The femtocell is a system (having a coverage area of about dozens of meters in radius, for example) which covers an area smaller than a macrocell, a microcell, a picocell, and a nanocell used in the public network and is more likely installed at home.

The femtocell is installed being mixed with the public network, and used as a system different from usual public networks.

The first wireless communication system is used for communication with the femtocell, whereas the second wireless communication system is used for communication with the public network. The femtocell has only limited number of users to connect to, which enables a high-speed communication with the femtocell. The wireless communication terminal capable of using the first wireless communication system can be used (for idle, communication and the likes) in either system. Likewise, the wireless communication terminal capable of using the second wireless communication system can also be used (for idle, communication and the likes) in either system.

Since both of the wireless communication systems are compatible, the wireless communication terminal capable of using the first wireless communication system generally searches for the first wireless communication system first as an idle system. However, if not being able to detect the first wireless communication system, the wireless communication terminal capable of using the first wireless communication system becomes idle in the second wireless communication system (only if the second wireless communication system is detected). Accordingly, the wireless communication terminal capable of using the first wireless communication system becomes idle in only one of the first wireless communication system and the second wireless communication system, and thus does not become idle in both of the wireless communication systems at once (choice between the two).

An existing wireless communication terminal capable of using the first wireless communication system and the second wireless communication system is designed to determine an access point at transmission as follows:

(1) The access point at transmission is a current idle base station.

(2) At certain intervals, the wireless communication terminal scans systems registered in PRL (Preferred Roaming List) and having higher priority than the current idle system. When succeeds in scanning, the wireless communication terminal performs reselection to change the base station (see FIG. 3).

(3) The wireless communication terminal performs transmission to the current idle base station. The wireless communication terminal scans base stations which enable communication at higher speed, if conditions (a) to (e) as follows are satisfied:
(a) Scanning is performed when a certain period has passed since disconnection of the communication.
(b) Scanning is performed at certain intervals when an idle state is ongoing.
(c) When a plurality of the same systems is registered in PRL, the systems are listed in order of higher speed (see FIG. 4(a)).
(d) When a plurality of different systems is registered in PRL, they can be listed in any order, although the same systems are registered in order of higher speed in the same manner as the above (c) (see FIG. 4(b)).
(e) The system of the femtocell is listed at the top of PRL.

FIG. 5 is a flowchart showing a packet transmission processing carried out by the wireless communication terminal with the base station in the existing mobile communication system. The packet transmission processing shown in FIG. 5 is initiated at operation of packet transmission. At step S51, the wireless communication terminal checks the idle state. If it is out of service area, the processing proceeds to step S52, whereas the processing proceeds to one of step 54 to step 56 if it is within a service area. At step S52, the wireless communication terminal performs scanning in out-of-service area. If scanning in out-of-service area is successful and the answer is YES at step S53, the proceeding returns to step S51 to check the idle state again. In contrast, if scanning in out-of-service area is failed and the answer is NO at step S53, the processing ends as it stands.

When it is detected that the wireless communication terminal is within the service area at step S51 and both CDMA 2000 1x (hereinafter, referred to as 1x) and CDMA 2000 1x EV-DO (hereinafter, referred to as EV-DO) are available, the processing proceeds to step S54 to transmit packets of EV-DO, which is a high-level system. The processing proceeds to step S55 to transmit packets of 1x if 1x alone is available, whereas the processing proceeds to step S56 to transmit packets of EV-DO if EV-DO alone is available.

At step S57 after step S54 to step S56, it is checked whether transmission of the packets is successful. When transmission of the packets is successful, the processing ends as it stands, whereas the processing shifts to step S52 to perform scanning in out-of-service area if transmission of the packets is failed. When scanning in out-of-service area is successful and the answer is YES at step S53, the processing returns to step S51 to check the idle state again, whereas the processing ends as it stands if scanning in out-of-service area is failed and the answer is NO at step S53.

Non Patent Document 1: “cdma2000 High Rate Packet Data Air Interface 3GPP2 C.S0024 Version 4.0”, 3GPP2, October 2002 (Section 8.5.6.1, Section 9.3.1.3.2.3.2)

Non Patent Document 2: “cdma2000 High Rate Packet Data Air Interface 3GPP2 C.S0024-A Version 2.0”, 3GPP2, July 2005 (Section 13.2.1.3.1.1, Section 13.3.1.3.1.1)

### DISCLOSURE OF THE INVENTION

### Problems to be Solved by the Invention

An existing wireless communication terminal capable of using both of the first wireless communication system and the second wireless communication system is configured to perform transmission to the current idle base station and does not perform scanning for the femtocell if being on idle in the public network. The existing wireless communication terminal capable of using both of the first wireless communication system and the second wireless communication system performs transmission in the public network when being on idle in the public network, and once a system for connection is selected, reselection (research) is performed not frequently but only at particular timings (at handoff, immediately after end of communication, after a predetermined period since end of communication). Therefore, the existing wireless communication terminal capable of using both of the first wireless communication system and the second wireless communication system may not use its full potential as a wireless communication terminal.

Reasons for not scanning base stations corresponding to the femtocell are “For immediacy of connection, it is necessary to shorten a time to connect.”, “It is considered to be possible to become idle to the base station listed at the top of PRL only by periodical selection operation after disconnection and during the idle state.”, and the likes.

It is a first object of the present invention to provide a control method of a wireless communication terminal capable of changing its connection to a base station which enables high speed communication, by performing reselection before connection.

It is a second object of the present invention to provide a wireless communication terminal capable of changing its connection to a base station which enables high speed communication, by performing reselection before connection.

### SUMMARY OF THE INVENTION

In order to achieve the above first object, a control method of a wireless communication terminal according to the present invention is a control method of a wireless communication terminal capable of using a first wireless communication system supporting communication with a femtocell and a second wireless communication system supporting communication with a public network, wherein the second wireless communication system is in an idle state and the first wireless to communication system is not in the idle state, and includes performing system scan of the first wireless communication system, when a transmission request of communication is detected, before corresponding transmission processing is performed by the second wireless communication system in the idle state, and performing the transmission processing, if the first wireless communication system is detected by the system scan of the first wireless communication system, not by the second wireless communication system in the idle state but by the first wireless communication system.

In the control method of the wireless communication terminal according to one embodiment of the present invention, if the first wireless communication system is not detected by the system scan of the first wireless communication system, the transmission processing is performed by the second wireless communication system in the idle state.

In order to achieve the above second object, the wireless communication terminal according to the present invention is capable of using a first wireless communication system supporting communication with a femtocell and a second wireless communication system supporting communication with a public network, and includes a detection unit for detecting a transmission request of communication, a system scan unit for performing system scan of the first wireless communication system, and a control unit for controlling, if the detection unit detects the transmission request when the second wireless communication system is in an idle state and the first wireless communication system is not in the idle state, the system scan unit to perform system scan of the first wireless communication system before corresponding transmission processing is performed by the second wireless communication system in the idle state and for controlling, if the first wireless communication system is detected by system scan, the transmission processing to be performed not by the second wireless communication system in the idle state but by the first wireless communication system.

In the wireless communication terminal according to another embodiment of the present invention, the control unit, if the first wireless communication system is not detected by the system scan, controls the transmission processing to be performed by the second wireless communication system in the idle state.

### EFFECT OF THE INVENTION

According to the present invention, it is possible to provide the control method of the wireless communication terminal and the wireless communication terminal capable of changing its connection to a base station of a system which enables high speed communication, by performing reselection before connection.

### BRIEF DESCRIPTION OF DRAWINGS

FIG. 1 is a block diagram illustrating an example of a configuration of a wireless communication terminal used for a mobile communication system capable of applying the control method according to a first embodiment of the present invention;

FIG. 2 is a flowchart showing packet transmission processing performed by the wireless communication terminal with a base station in the mobile communication system according to the first embodiment;

FIG. 3 is a diagram illustrating reselection carried out by an existing wireless communication terminal capable of using a first wireless communication system and a second wireless communication system;

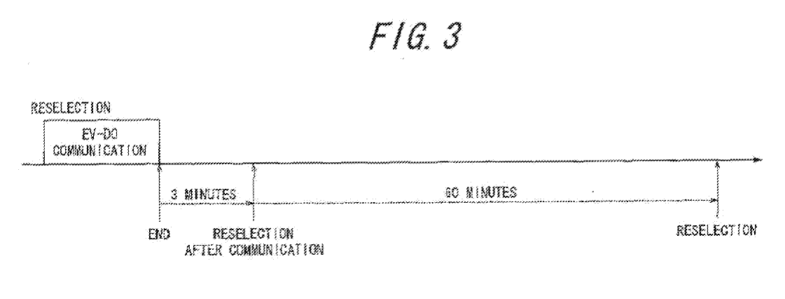

FIGS. 4 (a) and (b) are diagrams illustrating examples of PRL, (Preferred Roaming List) used in an existing mobile communication system corresponding to the first wireless communication system and the second wireless communication system; and

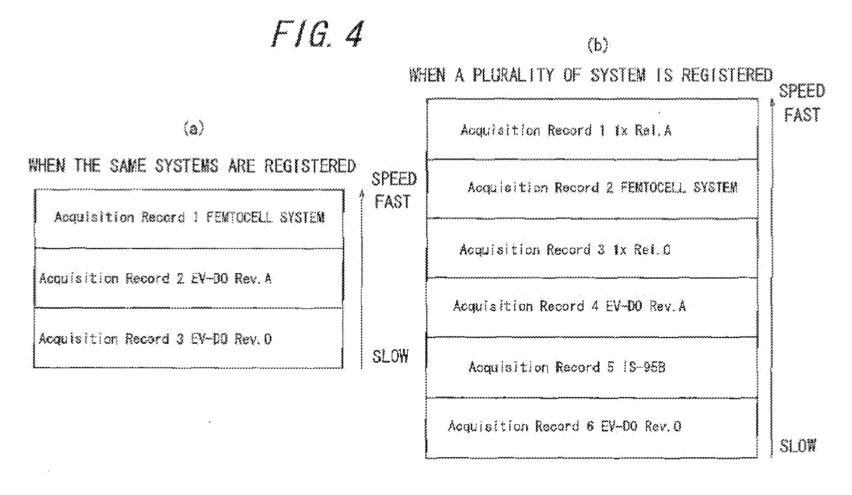

FIG. 5 is a flowchart showing packet transmission processing performed by the wireless communication terminal with the base station in the existing mobile communication system.

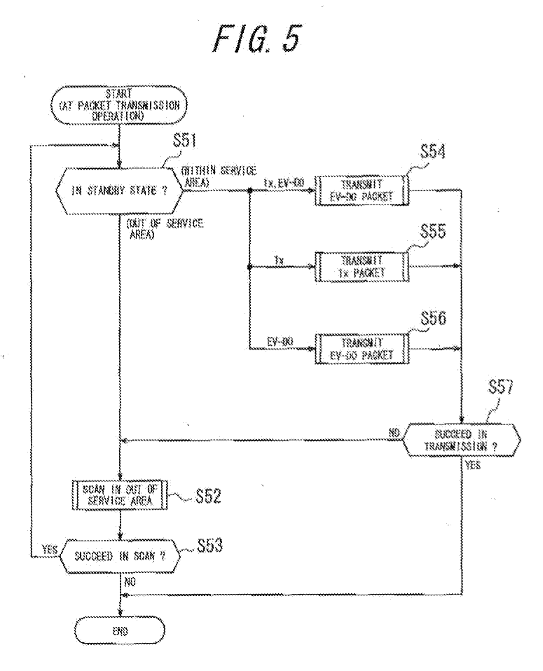

### DESCRIPTION OF EMBODIMENTS

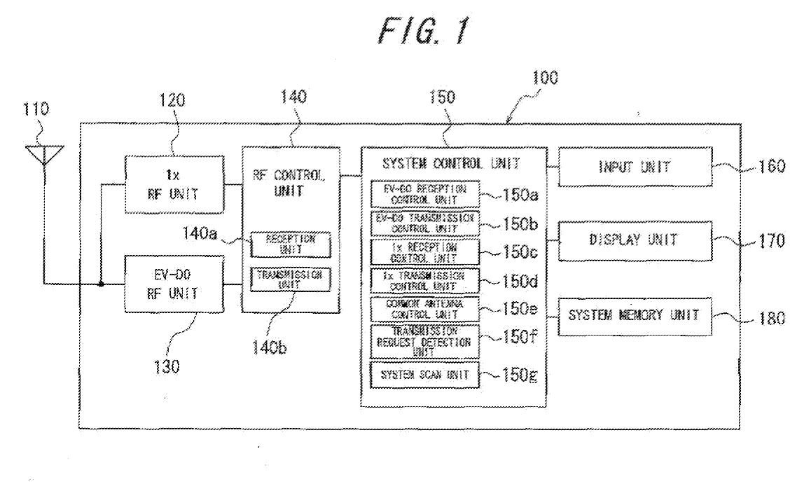

Preferred embodiments of the present invention will be described below with reference to the accompanying drawings. FIG. 1 is a block diagram illustrating an example of a configuration of a wireless communication terminal used in a mobile communication system capable of applying a control method according to a first embodiment of the present invention. A wireless communication terminal 100 according to the present embodiment is designed to switch CDMA 2000 1x system (hereinafter, referred to as 1x) and CDMA 2000 1x EV-DO system (hereinafter, referred to as EV-DO) by use of a common antenna 110 so as to perform data communication with a base station of each communication system. EV-DO system supports EV-DO Rev. A in addition to EV-DO Rev.0. In the following description, a system supporting communication with a femtocell (base station thereof) is a first wireless communication system, whereas a system supporting communication with a public network (base station thereof) is a second wireless communication system.

Since the first wireless communication system supporting the communication with the femtocell is an expanded system of the second wireless communication system supporting the communication with the public network and thus compatible therewith, the wireless communication terminal capable of using the first wireless communication system can be used (for idle, communication and the likes) in either system. Likewise, the wireless communication terminal capable of using the second wireless communication system can be used (for idle, communication and the likes) in either system.

Since both of the wireless communication systems are compatible, the wireless communication terminal capable of using the first wireless communication system generally searches for the first wireless communication system first as an idle system. However, if not being able to detect the first wireless communication system, the wireless communication terminal capable of using the first wireless communication system becomes idle in the second wireless communication system (only if the second wireless communication system can be detected). Accordingly, the wireless communication terminal capable of using the first wireless communication system becomes idle in only one of the first wireless communication system and the second wireless communication system and thus does not become idle in both of the wireless communication systems at once (choice between the two).

As shown in FIG. 1, the wireless communication terminal 100 according to the present embodiment is provided with the common antenna 110, a 1x RF unit 120, an EV-DO RF unit 130, an RF control unit 140, a system control unit 150, an input unit 160, a display unit 170, a system memory unit 180 and the likes. The RF control unit 140 is provided with a reception unit 140a and a transmission unit 140b. The system control unit 150 is provided with an EV-DO reception control unit 150a, an EV-DO transmission control unit 150b, a 1x reception control unit 150c, a 1x transmission control unit 150d, a common antenna control unit 150e, a transmission request detection unit 150f and a system scan unit 150g.

The 1x RF 120 unit converts data and audio signals to be transmitted by 1x system into high frequency signals and transmits the high frequency signals from the common antenna 110, and also converts data and audio signals input from the common antenna 110 into high frequency signals.

The EV-DO RF 130 unit converts data to be transmitted by EV-DO system into high frequency signals and transmits the high frequency signals from the common antenna 110, and also converts data input from the common antenna 110 into high frequency signals.

The RF control unit 140 controls communication of 1x system and of EV-DO system and measures the received signal strength indicator (RSSI) of signals from a base station (not shown) and received by the common antenna, and functions as the reception unit 140a and the transmission unit 140b based on high frequency singles input and output form/to the 1x RF unit 120 or the EV-DO RF unit 130. The reception unit 140a functions as an EV-DO reception unit and a 1x reception unit based on EV-DO protocol control by the EV-DO reception control unit 150a, 1x protocol control by the 1x reception control unit 150c and common antenna control by the common antenna control unit 150e, whereas the transmission unit 140b functions as an EV-DO transmission unit and a 1x transmission unit based on EV-DO protocol control by the EV-DO transmission control unit 150b, 1x protocol control by the 1x transmission control unit 150d and common antenna control by the common antenna control unit 150e.

The system control unit 150 performs overall control of each unit of the wireless communication terminal 100 and has a function to transmit a QoS setting request to a base station as well as another function to perform system scan and reselection, which will be described later.

By performing EV-DO protocol control, the EV-DO reception control unit 150a controls reception by EV-DO system in cooperation with common antenna control by the common antenna control unit 150e.

By performing EV-DO protocol control, the EV-DO transmission control unit 150b controls transmission by EV-DO system in cooperation with common antenna control by the common antenna control unit 150e.

By performing 1x protocol control, the 1x reception control unit 150c controls reception by 1x system in cooperation with common antenna control by the common antenna control unit 150e.

By performing 1x protocol control, the 1x transmission control unit 150d controls transmission by 1x system in cooperation with common antenna control by the to common antenna control unit 150e.

The common antenna control unit 150e performs common antenna control to switch the common antenna between transmission and reception. By the common antenna control, the wireless communication terminal 100 functions as a transmitter for performing transmission of EV-DO system and transmission of 1x system using the single common antenna 110 and also functions as a receiver for performing reception of EV-DO system and reception of 1x system using the common antenna 110.

The transmission request detection unit 150f detects a transmission request of EV-DO (a transmission request of EV-DO Rev. A or a transmission request of EV-DO Rev. 0).

The system scan unit 150g performs system scan of the first wireless communication system (which is a system supporting the communication with the femtocell).

The input unit 160 is provided with various keys and buttons and used for input of information and for making a selection among options displayed on a display screen of the display unit 170. It is to be noted that the input unit 160 and the display unit 170 can be omitted as necessary.

The system memory unit 180 is constituted of a memory such as a RAM and the likes and stores application programs and temporary data.

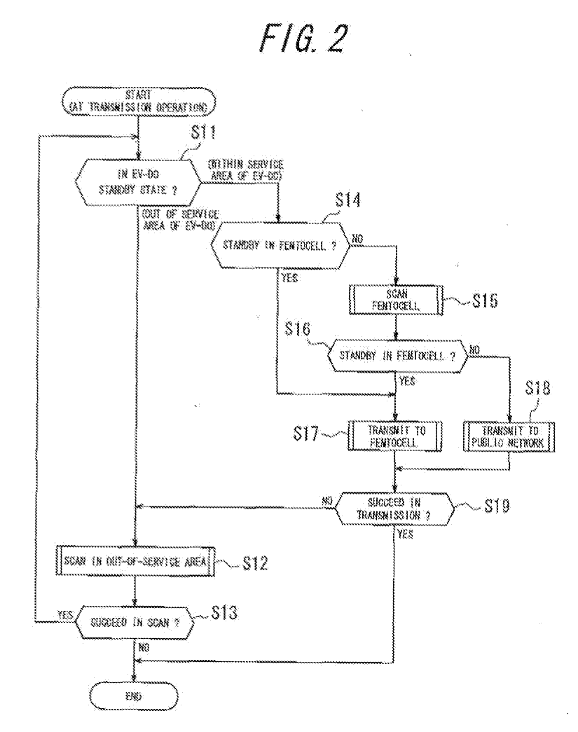

Next, a packet transmission processing carried out by the wireless communication terminal with the base station in the mobile communication system according to the present embodiment is described with reference to a flowchart shown in FIG. 2. Although the packet transmission processing shown in FIG. 2 is initiated at transmission operation of IPVT (Internet Protocol Video Telephony: a videophone which uses a packet-switched network), it may be initiated at transmission operation of something else.

First, the idle state of EV-DO is checked at step S11 shown in FIG. 2, and the processing proceeds to step S12 if it is out of service area of EV-DO, whereas the processing proceeds to step S14 if it is within a service area of EV-DO. At step S12, scanning in out-of-service area is performed. If scanning in out-of-service area is successful and either the femtocell or the public network (base station) is detected and thus the answer is YES at step S13, the processing returns to step S11, whereas the processing ends as it stands if scanning in out-of-service area is failed and the answer is NO at step S13.

When the wireless communication terminal is within the service area of EV-DO, the processing proceeds to step S14 where it is determined whether the wireless communication terminal is within a service area of the femtocell. If it is determined as NO (within the service area of public network), the processing proceeds to step S15, whereas the processing proceeds to step S17 if it is determined as YES (within the service area of the femtocell). At step S15 reselection (scan for the femtocell) is performed. At the following step S16, it is checked whether there is the femtocell. If the femtocell is detected, the processing proceeds to step S17 to perform transmission to the femtocell, whereas the processing proceeds to step S18 to perform transmission to the public network if the public network is detected.

At step S19 following step 17 and step 18, it is checked whether transmission is successful. If transmission is successful, the processing ends as it stands, whereas the processing proceeds to step S12 to perform scanning in out-of-service area if transmission is failed. If scanning in out-of-service area is successful and either one of the femtocell (the first wireless communication system) and the public network (the second wireless communication network) is detected and thus the answer is YES at step S13, the processing returns to step S11, whereas the processing ends as it stands if scanning in out-of-service area is failed and thus the answer is No at step S13.

Although the wireless communication terminal may be able to communicate with the femtocell when it has connected to the public network in the above packet transmission processing, the wireless communication terminal connects to the public network and communication traffic occurs, which incur inconvenience for a user. It is more inconvenient for the user not to be able to communicate with the femtocell, rather than to have slightly less immediacy for connection. According to the present invention, it increases a possibility to communicate with (transmit to) the femtocell by performing reselection (system scan of the femtocell) at transmission and scanning base stations of the femtocell even if the current idle system is the system of public network.

According to the present embodiment, by following steps through being within the service area of EV-DO at step S11, No of step S14, step S15, YES of step S16 and then step S17 shown in FIG. 2, the wireless communication terminal capable of using the first wireless communication system supporting the communication with the femtocell and the second wireless communication system supporting the communication to with the public network, when detecting a transmission request of communication while being in the idle state for the public network and not being in the idle state for the femtocell, performs system scan of the femtocell before performing a corresponding transmission processing to the public network in the idle state, and then performs the transmission processing to the femtocell without performing the transmission is processing to the public network if the femtocell is detected by the system scan of the femtocell. This increases possibility to realize high speed communication by the femtocell, leading to an improvement in convenience for the user. Thereby, it is possible to provide a control method of the wireless communication terminal and the wireless communication terminal capable of changing its connection to a base station of a system which enables the high speed communication.

In addition, according to the present embodiment, by following steps through being within the service area of EV-DO at step S11, NO of step S14, step S15, NO of step S16 and then step S18 shown in FIG. 2, the transmission processing is performed by the second wireless communication system (public network) in the idle state even if the first wireless communication system (femtocell) is not detected. It thus achieves the communication at least by the second wireless communication system (public network).

It is to be noted that, if the femtocell supports 1x system as well, it is possible that the transmission request detection unit 150f detects the transmission request of 1x and then, in the same manner as EV-DO system, the wireless communication terminal scans the femtocell and performs transmission to the femtocell by giving priority thereto.

It is to be understood that, although CDMA2000 1x system and CDMA2000 1x EV-DO system are assumed as the wireless communication system supporting the communication with the femtocell or the wireless communication system supporting the communication with the public network according to the above embodiment, the present invention is applicable not only to such wireless communication systems but also to a variety of wireless communication systems currently used such as WiFi (IEEE802.11), WiMAX (IEEE802.16), iBurst (registered trademark), LTE (Long Term Evolution), UMB (Ultra Mobile Broadband) and the likes, for example, as well as wireless communication systems expected to be put into practical use.

1. A control method of a wireless communication terminal capable of using a first wireless communication system supporting communication with a femtocell and a second wireless communication system supporting communication with a public network,
wherein the second wireless communication system is in an idle state and the first wireless communication system is not in the idle state,
the control method comprising:
performing system scan of the first wireless communication system, when a to transmission request of communication is detected, before corresponding transmission processing is performed by the second wireless communication system in the idle state; and
performing the transmission processing, if the first wireless communication system is detected by the system scan of the first wireless communication system, not by the second wireless communication system in the idle state but by the first wireless communication system.

2. The control method of the wireless communication terminal according to claim 1, wherein if the first wireless communication system is not detected by the system scan of the first wireless communication system, the transmission processing is performed by the second wireless communication system in the idle state.

3. A wireless communication terminal capable of using a first wireless communication system supporting communication with a femtocell and a second wireless communication system supporting communication with a public network, comprising:
a detection unit for detecting a transmission request of communication;
a system scan unit for performing system scan of the first wireless communication system; and
a control unit for controlling, if the detection unit detects the transmission request when the second wireless communication system is in an idle state and the first wireless communication system is not in the idle state, the system scan unit to perform the system scan of the first wireless communication system before corresponding transmission processing is performed by the second wireless communication system in the idle state and for controlling, if the first wireless communication system is detected by the system scan, the transmission processing to be performed not by the second wireless communication system in the idle state but by the first wireless communication system.

4. The wireless communication terminal according to claim 3, wherein the control unit controls, if the first wireless communication system is not detected by the system scan, the transmission processing to be performed by the second wireless communication system in the idle state.
